(19) United States
(12) Patent Application Publication
(10) Pub. No.: US 2017/0355312 A1
(43) Pub. Date: Dec. 14, 2017

(54) INTERIOR REARVIEW MIRROR ASSEMBLY WITH FULL SCREEN VIDEO DISPLAY

(71) Applicant: MAGNA MIRRORS OF AMERICA, INC., Holland, MI (US)

(72) Inventors: Hamid Habibi, Holland, MI (US); Justin E. Sobecki, Rockford, MI (US)

(21) Appl. No.: 15/613,357

(22) Filed: Jun. 5, 2017

Related U.S. Application Data
(60) Provisional application No. 62/466,089, filed on Mar. 2, 2017.
(60) Provisional application No. 62/347,349, filed on Jun. 8, 2016.

(51) Int. Cl. B60R 1/08; B60R 1/02; H04N 7/18

(52) U.S. Cl. CPC B60R 1/088; H04N 7/18; B60R 1/025; B60R 2300/8046

(57) ABSTRACT

An interior rearview mirror assembly for a vehicle includes a mirror-display assembly adapted to pivotally attach at an interior surface of the vehicle. The mirror-display assembly includes a mirror reflective element and a display device that has a display screen. The mirror reflective element is disposed at a mirror side of the mirror-display assembly and the display screen is disposed at a display side of the mirror-display assembly. The mirror-display assembly is pivotable between a mirror position and a display position. When the mirror-display assembly is in the mirror position, a driver of the vehicle views the mirror reflective element and does not view the display screen, and when the mirror-display assembly is in the display position, the driver of the vehicle views the display screen and does not view the mirror reflective element. The mirror-display assembly pivots about a pivot axis between the mirror position and the display position.

### CROSS REFERENCE TO RELATED APPLICATIONS

The present application claims the filing benefits of U.S. provisional application Ser. No. 62/466,089, filed Mar. 2, 2017, and U.S. provisional application Ser. No. 62/347,349, filed Jun. 8, 2016, which are hereby incorporated herein by reference in their entireties.

### FIELD OF THE INVENTION

The present invention relates generally to the field of interior rearview mirror assemblies for vehicles and, more particularly, to interior rearview mirror assemblies with a display.

### BACKGROUND OF THE INVENTION

It is known to provide a mirror assembly that is adjustably mounted to an interior portion of a vehicle, such as via a double ball pivot or joint mounting configuration where the mirror casing and reflective element are adjusted relative to the interior portion of a vehicle by pivotal movement about the double ball pivot configuration. The mirror casing and reflective element are pivotable about either or both of the ball pivot joints by a user that is adjusting a rearward field of view of the reflective element. It is also generally known to provide a display screen at the mirror assembly. The mirror assembly may include a video display screen disposed in the mirror casing behind a display portion of the reflective element so as to be viewable, when activated, through a transflective mirror reflector of the reflective element.

### SUMMARY OF THE INVENTION

The present invention provides an interior rearview mirror assembly that includes an electro-optic mirror reflective element and a display device operable to display information for viewing by the driver of the vehicle. The display screen of the display device substantially spans the height and width of the mirror reflective element. The reflective element and display are part of a mirror head or display and reflective element assembly that is rotatable about 180 degrees about a generally horizontal axis, such that, when in a mirror position, the mirror assembly has the reflective element facing the driver of the vehicle, and in a display position (about 180 degrees rotation from the mirror position), the display device is facing the driver of the vehicle.

Thus, the present invention provides a mirror reflective element and display assembly that allows for enhanced reflectance at the mirror reflective element (since the reflective element does not have to be transmissive to allow for viewing of the display device through the reflective element) and that provides enhanced viewing of the displayed images (since they are not attenuated by passing through a partially transmissive reflective element).

These and other objects, advantages, purposes and features of the present invention will become apparent upon review of the following specification in conjunction with the drawings.

### BRIEF DESCRIPTION OF THE DRAWINGS

FIG. 1 is a perspective view of an interior rearview mirror assembly in accordance with the present invention;

FIG. 2 is a sectional view of a mirror reflective element and display assembly in accordance with the present invention;

FIG. 3 is a side view of the mirror reflective element and display assembly, showing the reflective element angled or non-parallel relative to the display screen;

FIG. 4 is a plan view of a mirror reflective element and display assembly of the present invention;

FIG. 5 is another plan view of the mirror reflective element and display assembly, shown with a mounting structure that allows for pivoting of the mirror reflective element and display assembly about a generally horizontal pivot axis;

FIG. 6 is a perspective view of another interior rearview mirror assembly in accordance with the present invention, shown in a mirror orientation;

FIG. 7 is a perspective view of the interior rearview mirror assembly of FIG. 6, shown in a display orientation;

FIG. 8 is another perspective view of the interior rearview mirror assembly, shown in the display orientation and showing the display region;

FIG. 9 is a sectional view of the interior rearview mirror assembly;

FIG. 10 is another sectional view of the interior rearview mirror assembly;

FIG. 11 is another sectional view of the interior rearview mirror assembly;

FIG. 12 is an exploded perspective view of the interior rearview mirror assembly;

FIG. 13 is another perspective view of the interior rearview mirror assembly in accordance with the present invention, shown in a mirror orientation;

FIG. 14 is another perspective view of the interior rearview mirror assembly, shown in a display orientation;

FIG. 15 is another perspective view of the interior rearview mirror assembly of FIG. 13, showing the mirror reflection rearward view;

FIG. 16 is another perspective view of the interior rearview mirror assembly of FIG. 14, showing a displayed image captured by a rearward viewing camera;

FIG. 17 is another perspective view of the interior rearview mirror assembly;

FIG. 18 is a plan view of the interior rearview mirror assembly, shown in the mirror orientation;

FIG. 19 is another perspective view of the interior rearview mirror assembly;

FIG. 20 is another perspective view of the interior rearview mirror assembly; and

FIG. 21 is another sectional view of the interior rearview mirror assembly, showing an optional lateral pivoting of the mirror head.

### DESCRIPTION OF THE PREFERRED EMBODIMENTS

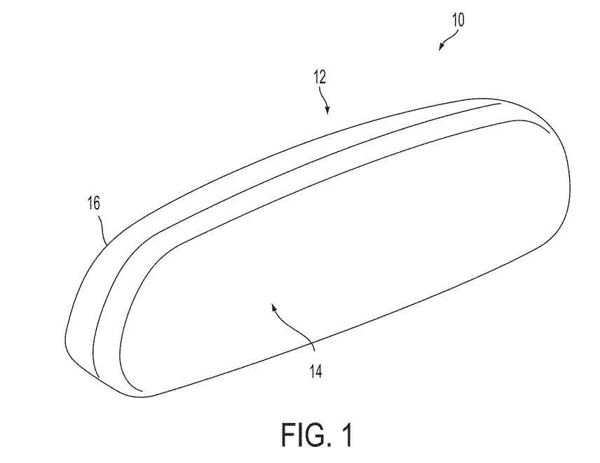

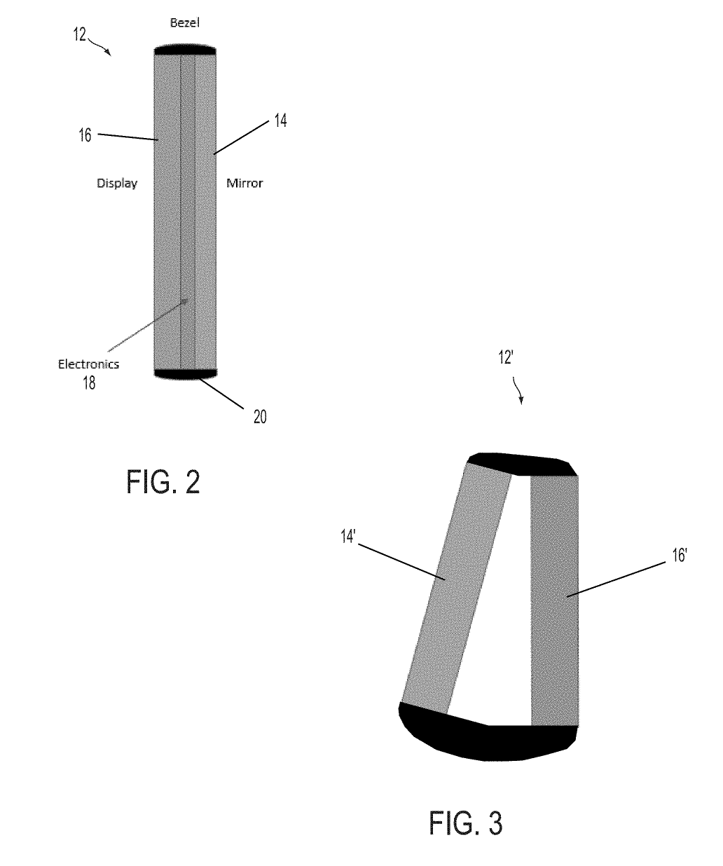

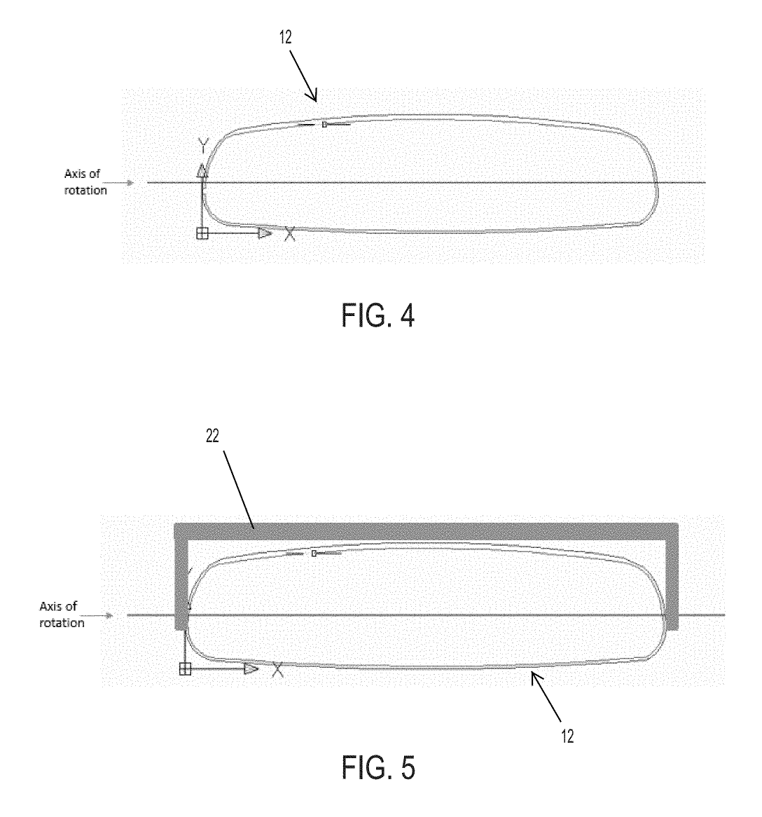

Referring now to the drawings and the illustrative embodiments depicted therein, an interior rearview mirror assembly 10 for a vehicle includes a mirror head or mirror and display assembly or mirror-display assembly 12 that includes a reflective element 14 and a display device 16, which provides a display area visible to the driver of the vehicle through the reflective element 14 (FIGS. 1 and 2). The mirror assembly 10 is configured to be adjustably mounted to an interior portion of a vehicle (such as to an interior or in-cabin surface of a vehicle windshield or a headliner of a vehicle or the like) via a mounting structure or mounting configuration or assembly. The mirror head 12 of the interior rearview mirror assembly 10 may house all or a portion of the components of the interior rearview mirror assembly 10 and may be integrally formed with portions thereof.

The mirror head 12 comprises the display device 16 on one side and the reflective element 14 at the other side. The reflective element may comprise any suitable reflective element, such as an electro-optic (such as electrochromic) variable reflectance reflective element or such as a prismatic reflective element. The reflective element need not have a transflective (partially reflective and partially transmissive) mirror reflector, since the display screen is not viewable through the reflective element. As shown in FIG. 2, the mirror head may also include electronics 18 (such as a glare sensor, an ambient light sensor, a camera, electro-optic drive circuitry, display circuitry, lights, and/or the like) disposed in a space between the reflective element 14 and the display device 16. A bezel or surround structure 20 may be disposed about the periphery of the reflective element 14 and the display device 16 to secure the elements together and to encase or enclose the central cavity where electronics 18 or the like may be disposed.

Electrical connection to the electronics 18 may be provided via one or more wires that may pass through the bezel 20 to a mounting connection of a mounting structure 22 (FIG. 5). The electrical connection allows for rotation of the mirror head 12 relative to the mounting structure 22 while maintaining electrical connection to the electronics 18. For example, the electrical connection may comprise wires that have sufficient play to allow for twisting in one direction or the other (where pivotal movement of the mirror head may be mechanically limited to about 180 degrees) or the electrical connection may comprise a sliding contact that may allow for full 360 degrees of rotation of the mirror head relative to the mounting structure 22.

In the illustrated embodiment, the mirror head rotates around a generally horizontal axis. There is no housing, but rather has a video display screen on one side and a mirror reflective element on the other side. The electronics and wiring is disposed between the display device and the reflective element and surrounded by the bezel. The bezel may provide curved perimeter edge regions so as to provide a smooth curved transition between the front (viewed) surface of the reflective element and the side wall or surface of the bezel and to provide a smooth curved transition between the front (viewed) surface of the video display screen and the side wall or surface of the bezel. The bezel is disposed around the assembly to cover all the connections. The wiring can be routed at the point where the mirror connects to the frame or mounting structure.

When the mirror head is pivoted to the display orientation or position, the reflective element may face forward in the direction of travel of the vehicle and thus would be facing traffic approaching the equipped vehicle. Thus, it is desirable to provide a masking element that may be disposed in front of the mirror head so as to block the reflective element (and the display device when the mirror head is in the mirror position) from view by drivers of other vehicles ahead of or approaching the equipped vehicle. Optionally, and such as can be seen in FIG. 3, the mirror reflective element may not be parallel or aligned with the display screen, such that, when the mirror head 12′ is in its display orientation (with the display device 16′ at the desired angle for viewing by the driver of the vehicle), the reflective element 14′ (now facing forwardly towards leading and oncoming traffic) is angled upward toward an upper portion of the vehicle windshield (or optionally the mirror head may be constructed so, when in the display position, the reflective element is angled downwardly). In such a configuration, the assembly may have to be able to rotate or pivot more than about 180 degrees to pivot between the display position and the mirror position. Optionally, and desirably, the mirror reflective element may be angled at least about 10 degrees relative to the display device, and optionally at least about 20 degrees, and optionally at least about 30 degrees relative to the display device, in order to have the reflective element angle sufficiently upward or downward when the mirror head is in the display mode or position. Optionally, it is envisioned that the reflective element may be generally orthogonal to the display device, such that the mirror head rotates about 90 degrees (or other suitable angle) between the display position and the mirror position (whereby the depth of the mirror head increases, such that clearance for such a construction would be needed at the mounting structure and windshield).

As shown in FIG. 5, the mirror head may be pivotally mounted at a mounting structure 22 that allows for rotation of the mirror head about a generally horizontal pivot axis (or optionally that allows for rotation of the mirror head about a generally vertical pivot axis). The mounting structure may pivotally mount at an interior portion of the vehicle so that the mounting structure may pivot about a generally vertical axis (or any axis generally orthogonal to the pivot axis of the mirror head at the mounting structure) so that the driver may readily adjust the mirror assembly to provide the desired rearward field of view when the mirror head is in the mirror mode or position. Optionally, the mounting structure may otherwise provide for multi-axis adjustment of the mirror head to allow the driver of the vehicle to adjust the position of the mirror head to provide the desired rearward field of view when the mirror head is in the mirror mode or position.

Optionally, the mirror head may be otherwise mounted at a mounting structure to allow for pivotal movement of the mirror head to allow for separate viewing of the mirror reflective element (when the mirror head is in a mirror mode or position) and the video display screen (when the mirror head is in a display mode or position). Optionally, the mirror/display assembly may be disposed at or partially in a mirror casing or housing with a small gap between the mirror head and the mirror casing to allow for the mirror to rotate or pivot. When such a mirror/display structure is in a housing (such as similar to a mirror reflective element of an exterior rearview mirror assembly) where there is a gap between the mirror reflective element and the housing to allow for the adjustment and pivoting or rotating of the mirror head, there is no concern about reflection off the mirror reflective element (when the mirror head is in the display position) into oncoming traffic.

Thus, the mirror head is pivotable to adjust or position the mirror head between a mirror mode or position (where the driver of the vehicle views the mirror reflective element for rearward viewing, and where the mirror head may be adjustable about multiple pivot axes to allow for adjustment of the rearward field of view for the particular driver) and a display mode or position (where the driver of the vehicle views the video display screen). The mirror head may be automatically pivoted or rotated (such as via a motor or actuator at the mirror mounting structure or the like) between the mirror mode and the display mode, such as in response to a user input or the like (for example, a user may press a button or toggle to switch between the modes, or the system may automatically rotate the mirror head to the display mode when the vehicle is shifted into reverse gear for a backup assist camera system). If there is a power failure or actuator failure, the driver can manually rotate the mirror head to the mirror mode or position so that the mirror reflective element is viewable by the driver and can be used for normal driving.

Optionally, the mirror head may be manually pivoted or rotated by the driver as desired. Optionally, and desirably, the display device is only activated for displaying images when the mirror head is in the display mode or position and is not operable when the mirror head is in the mirror mode or position. Similarly, the electro-optic mirror reflective element may only be operated when the mirror head is in the mirror mode or position and may not be operable (such that the glare light sensor may be deactivated and the electro-optic control circuitry may be deactivated) when the mirror head is in the display mode.

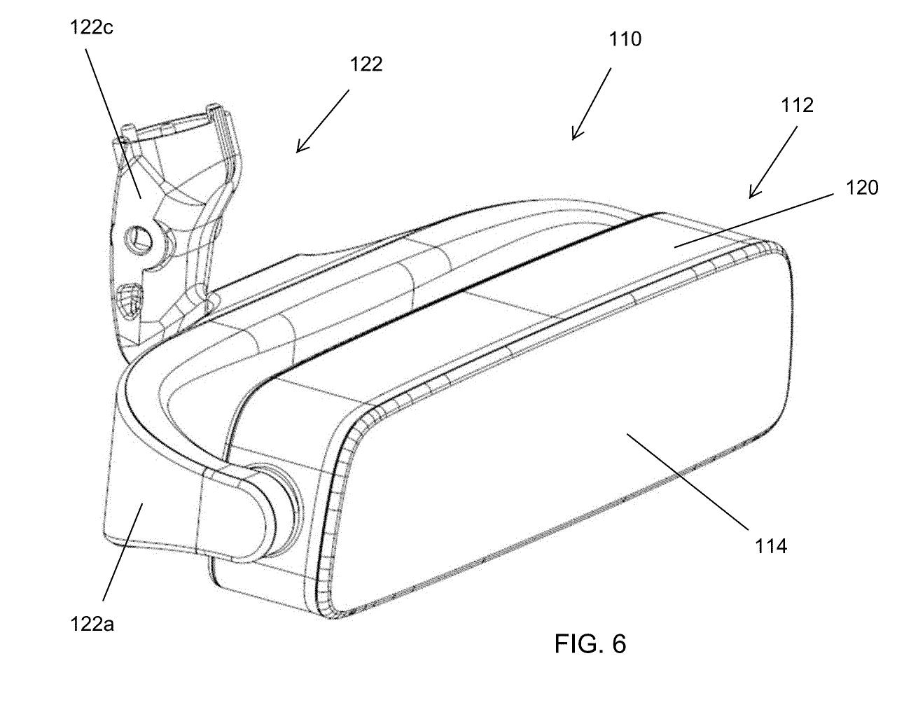

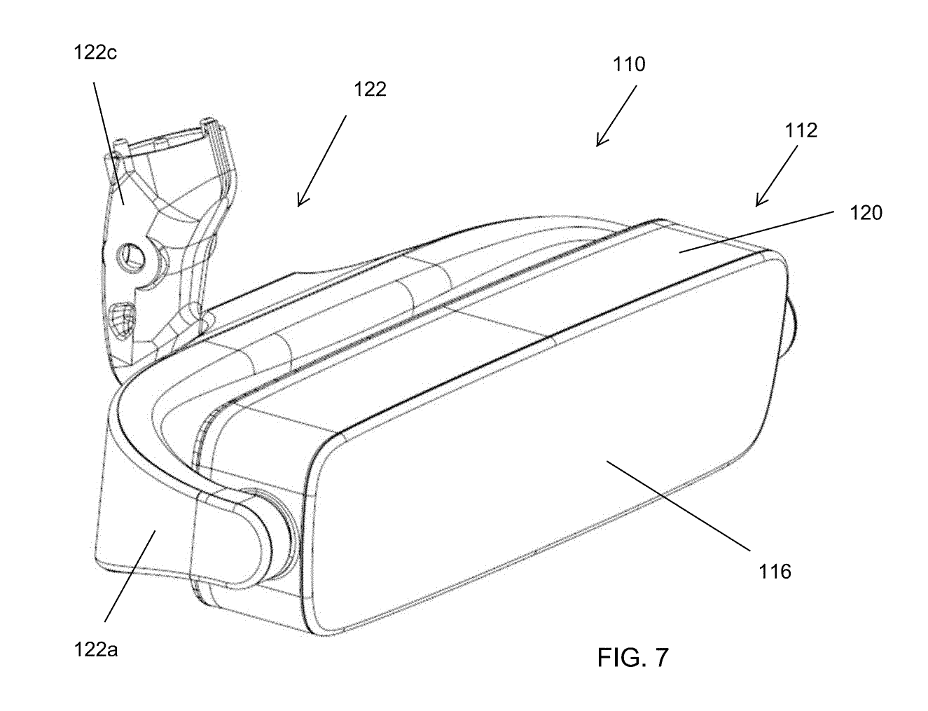

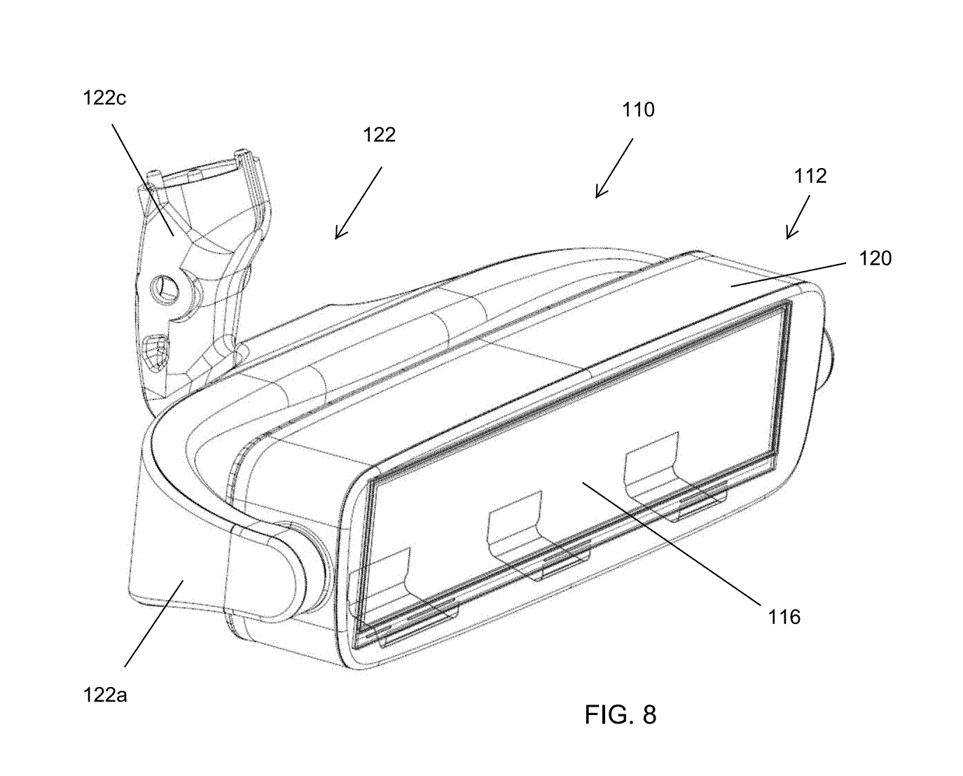

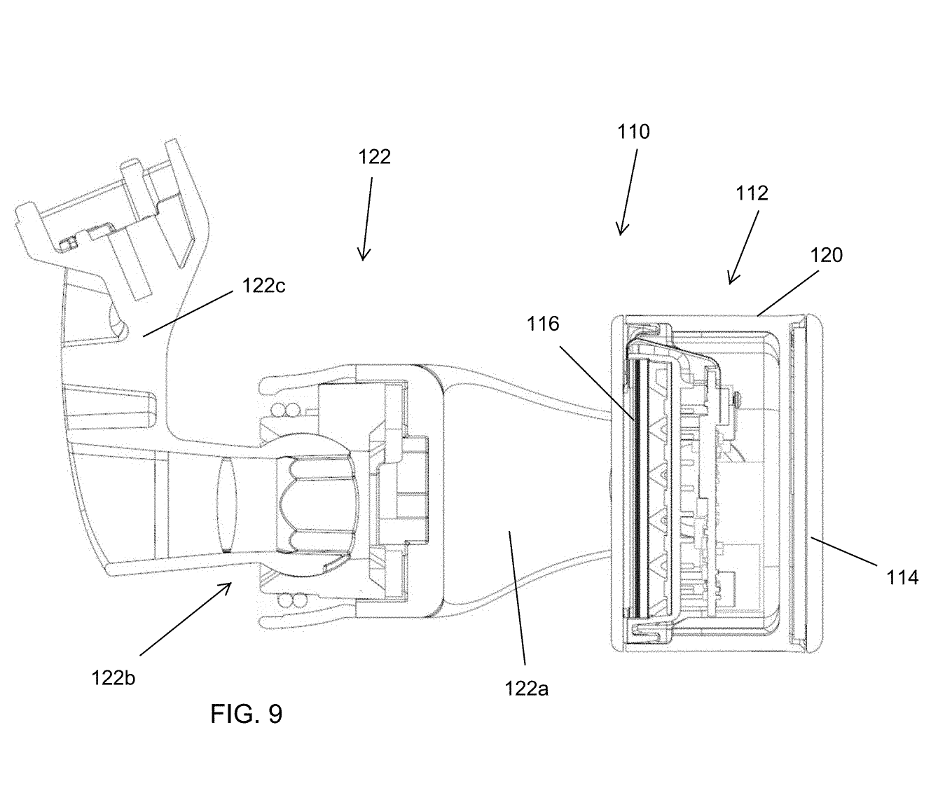

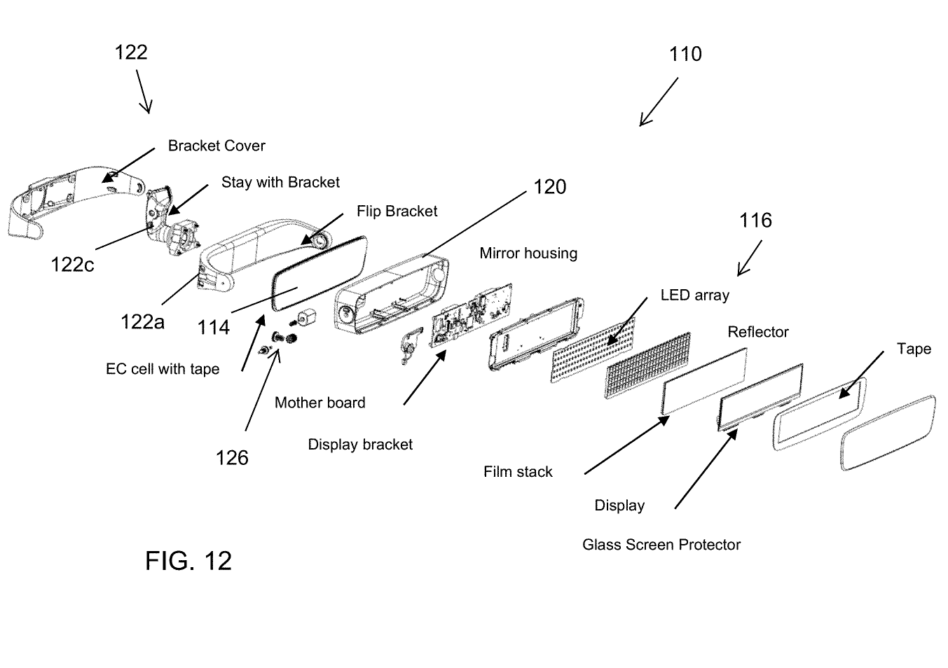

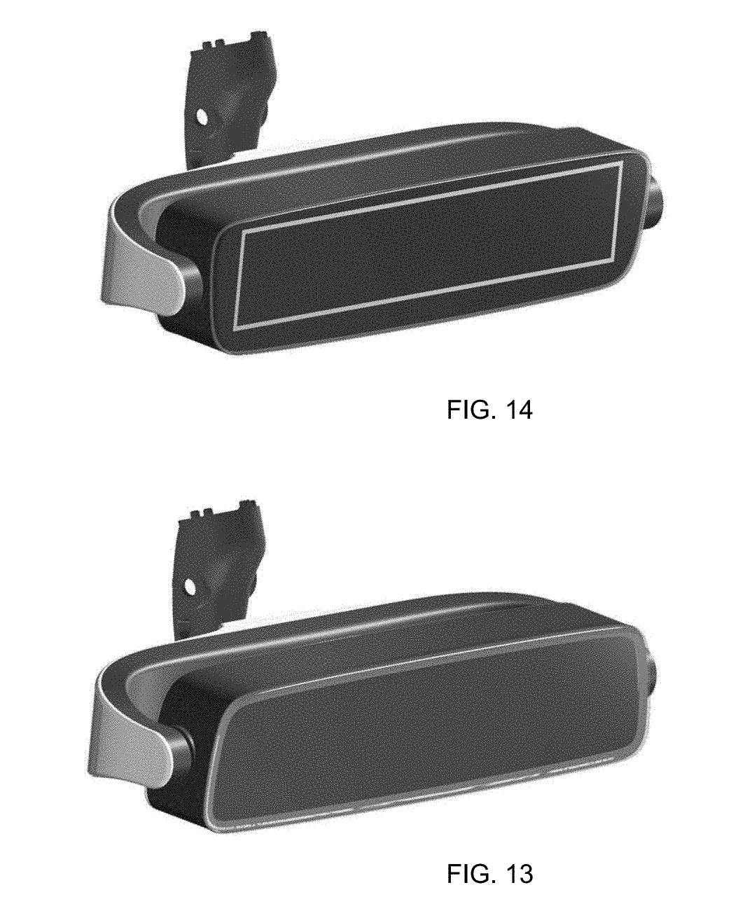

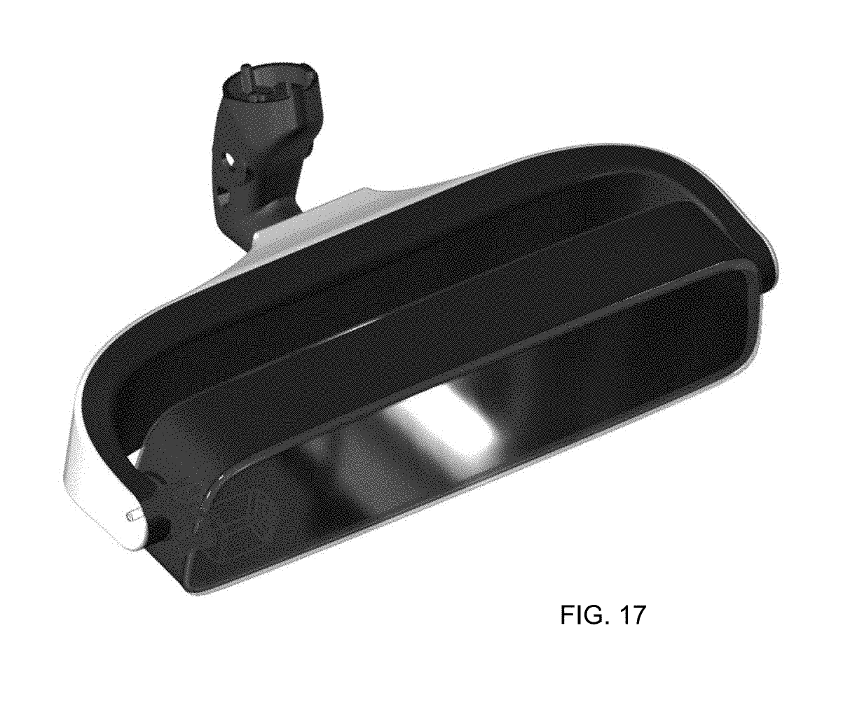

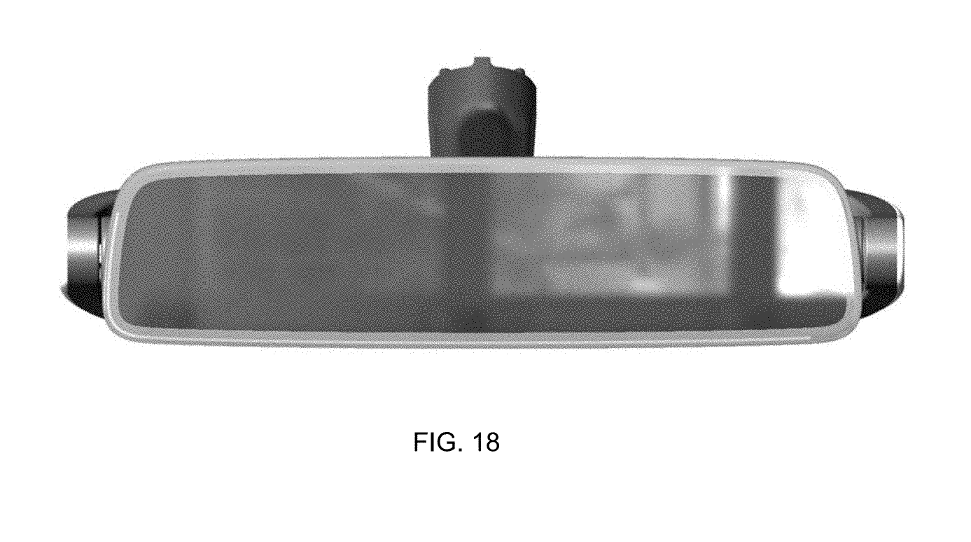

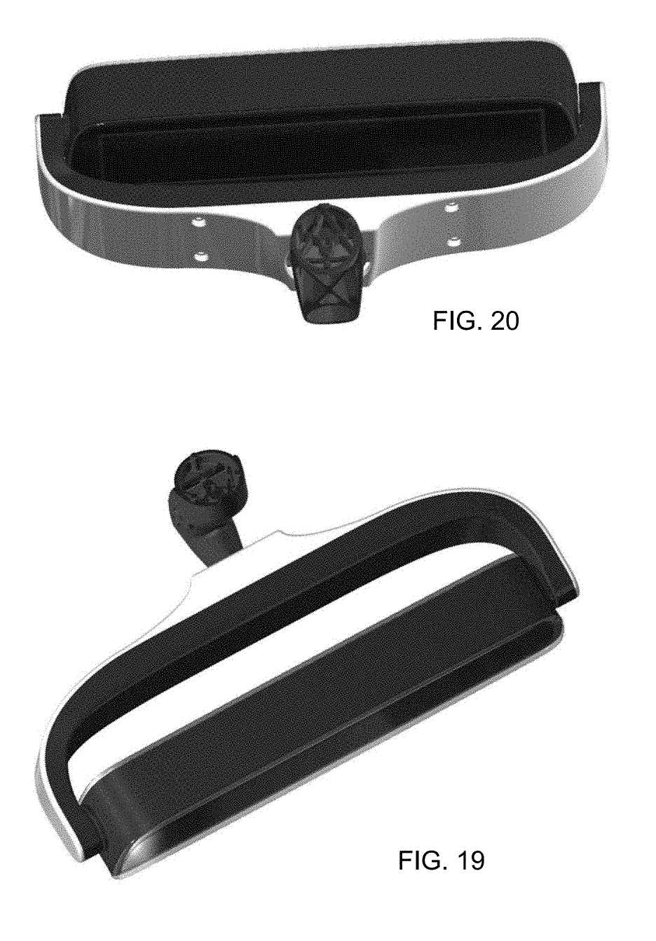

Referring now to FIGS. 6-20, an interior rearview mirror assembly 110 for a vehicle includes a mirror head 112 that includes a reflective element 114 and a display device 116, with the mirror head 112 pivotally mounted at a mounting structure 122 and pivotable about a generally horizontal axis (or an axis extending longitudinally along a length axis of the mirror head) between a mirror orientation (FIGS. 6, 9-11, 13, 15 and 17-20) and a display orientation (FIGS. 7, 8, 12, 14 and 16). The mirror head 112 comprises the display device 116 on one side and the reflective element 114 at the other side. The reflective element may comprise any suitable reflective element, such as an electro-optic (such as electrochromic) variable reflectance reflective element or such as a prismatic reflective element. The reflective element need not have a transflective (partially reflective and partially transmissive) mirror reflector, since the display screen is not viewable through the reflective element. As shown in FIGS. 9-12, the mirror head may also include electronics 118 (such as a glare sensor, an ambient light sensor, a camera, electro-optic drive circuitry, display circuitry, lights, and/or the like) disposed in a space between the reflective element 114 and the display device 116. A bezel or surround structure 120 may be disposed about the periphery of the reflective element 114 and the display device 116 to secure the elements together and to encase or enclose the central cavity where electronics 118 or the like may be disposed.

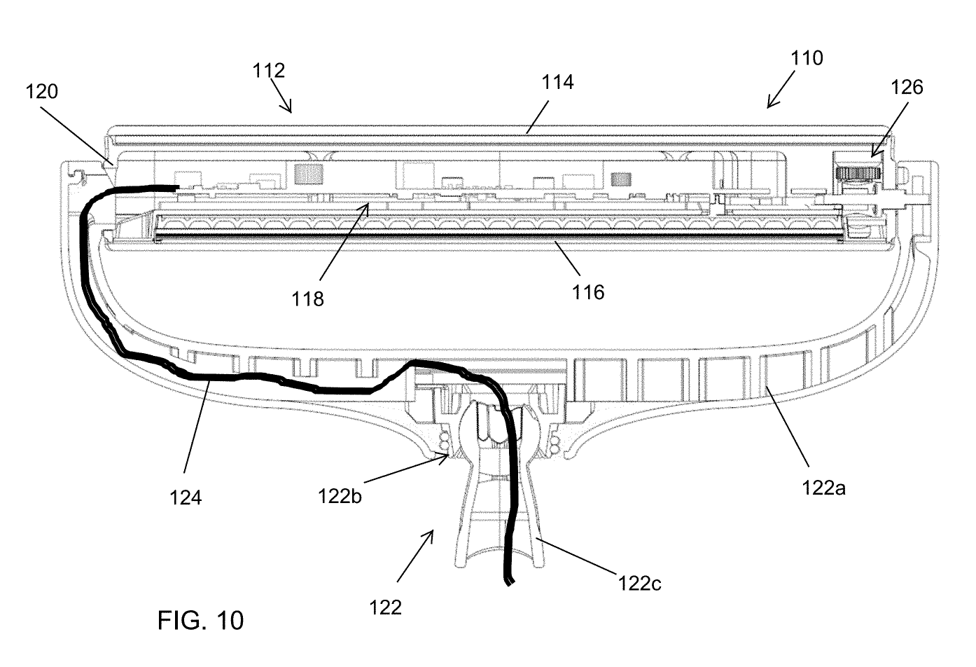

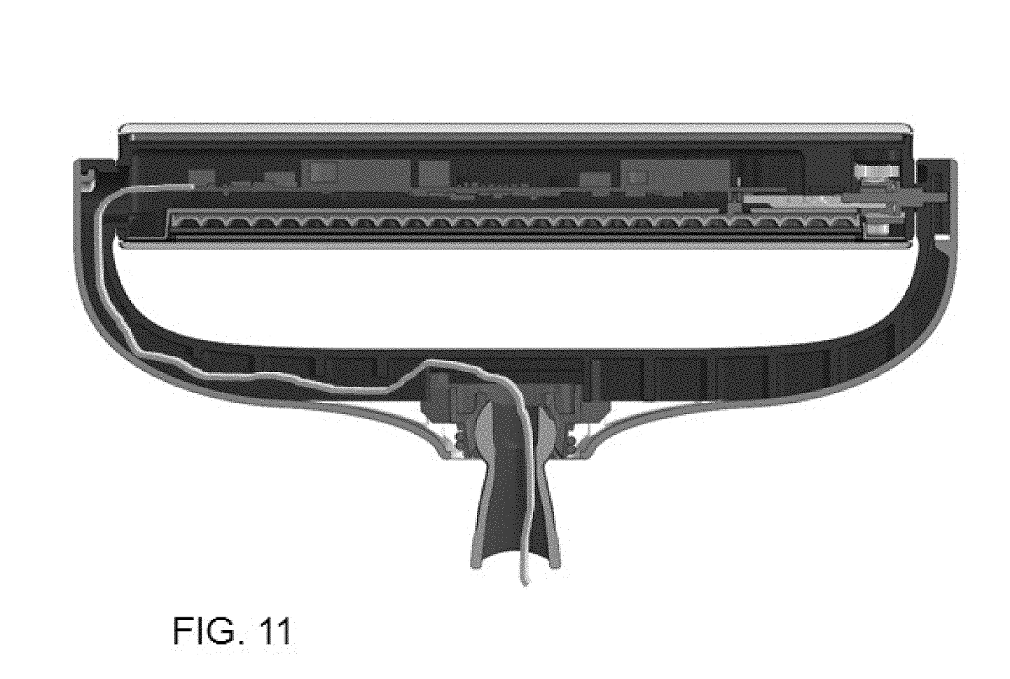

Electrical connection to the electronics 118 may be provided via one or more wires 124 that may pass through the bezel 120 to a mounting connection of a mounting structure 122 (FIGS. 10 and 11). The electrical connection allows for rotation of the mirror head 112 relative to the mounting structure 122 while maintaining electrical connection to the electronics 118. For example, the electrical connection may comprise wires that have sufficient play to allow for twisting in one direction or the other (where pivotal movement of the mirror head may be mechanically limited to about 180 degrees) or the electrical connection may comprise a sliding contact that may allow for full 360 degrees of rotation of the mirror head relative to the mounting structure 122.

In the illustrated embodiment, the mounting structure 122 comprises a generally U-shaped bracket 122a that pivotally attaches at its ends to the opposite ends of the mirror head 112. The bracket 122a pivotally mounts at a pivot joint 122b at a mirror mount 122c. The pivot joint 122b comprises a ball and socket pivot joint. The mirror mount 122c is configured to attach at an interior portion of a vehicle, such as at a header of the vehicle or such as at an interior surface of the vehicle windshield.

As shown in FIGS. 10-12 and 17, the mirror head 112 includes a motorized actuator 126 that, when powered (such as via a user input or vehicle input), pivots the mirror head relative to the bracket 122a. The motor of the actuator may be disposed at the circuit board in the mirror head and may rotatably drive one or more gears that engage a geared or toothed pin at the bracket 122a, such that rotational driving of the gears causes pivotal movement of the mirror head relative to the bracket 122a.

The mirror-display assembly of the present invention thus provides enhanced mirror-based display that includes increased brightness of the display (since the display is not displaying through a transflective reflective element), and provides for such increased brightness with decreased power for driving the display backlight or LED array. By moving the EC cell so that it is not in front of the display when display is on, the system increases the efficiency by about four times and reduces the amount of power needed to power the backlight. Optionally, the mirror assembly may include an edge light backlight with less LEDs, better uniformity, less films, and thinner backlight design. The assembly also reduces the amount of display ghost images caused by the different surfaces of the EC cell. Also, because the display is not viewed through the electrochromic (EC) cell, the EC cell does not need display on demand (DOD) transflective coatings (that are partially reflective and partially transmissive of light incident thereat). This provides for enhanced uniformity of the reflective surface of EC (and does not require any window for display).

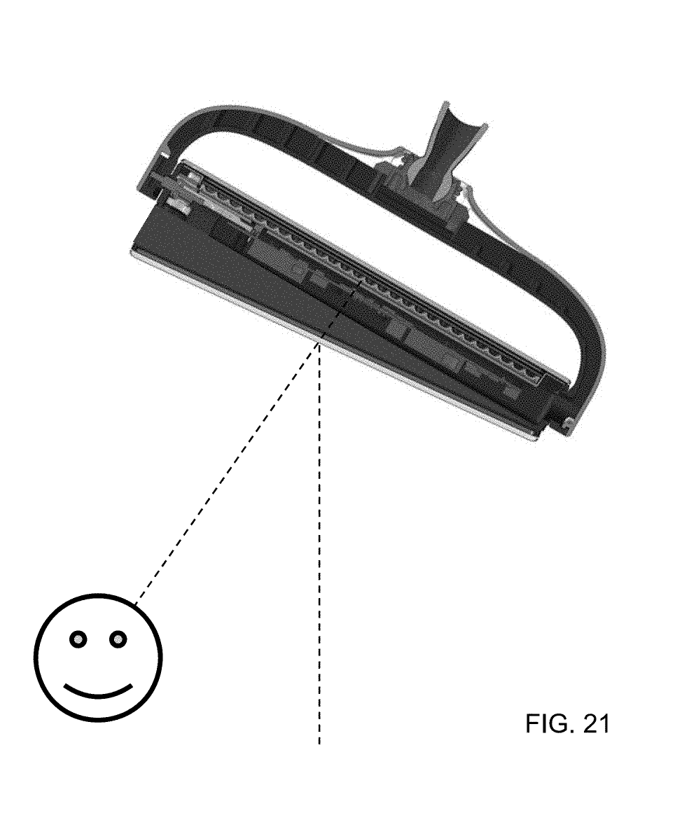

The mirror assembly provides for flipping of the entire mirror head to selectively position the mirror reflective element or the display screen for viewing by the driver of the vehicle. The mirror head may be flipped or rotated via a manual flipping function with a friction or detent clutch, or may be powered with a motor (that preferably includes a manual override so the driver can manually pivot the mirror head to the desired orientation. The manual version may include a gravity switch in the mirror head that automatically turns on the display when the mirror head is pivoted or flipped to the display orientation. Optionally, and such as shown in FIG. 21, the reflective element may be at an angle relative to the display screen to adapt the mirror head to provide a direct view of the display screen when the mirror head is in the display orientation and an angled view of the reflective element when the mirror head is in the reflecting mirror orientation. Thus, when the mirror head is flipped between the mirror and display orientations, the driver need not laterally adjust the mirror head and bracket relative to the mirror mount. Optionally, the mirror head may be pivotable about a generally vertical axis (or axis normal to the rotational axis or flip axis) to adjust the mirror head laterally when the mirror head is flipped between the mirror and display orientations.

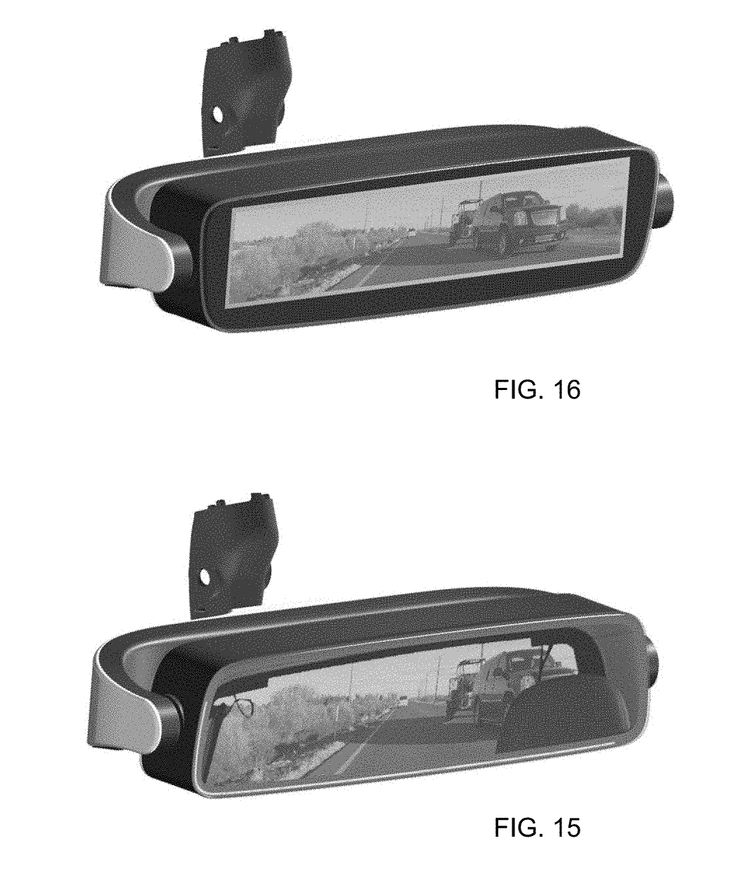

Thus, the mirror assembly includes an actuator that preforms the rotation of the mirror head to provide the desired function (mirror or display) for viewing by the driver of the vehicle. When the user actuates a user input or switch or button, the actuator pivots the mirror head to the display orientation and the digital display turns on and displays images for viewing by the driver of the vehicle (such as video images derived from image data captured by a camera of the vehicle). As can be seen with reference to FIGS. 15 and 16, when the mirror-display assembly is in the display mode or orientation (FIG. 16), the driver can view the displayed rearward scene without obstructions, such as rear window elements and headrests and the like, that are viewed in the reflection at the mirror reflective element when the mirror-display assembly is in the mirror mode or orientation (FIG. 15). Optionally, the mirror head may automatically pivot to the display orientation responsive to the driver of the vehicle shifting the vehicle transmission into a reverse gear, whereby video images captured by a rear backup camera may automatically be displayed at the display screen for viewing by the driver during a reversing maneuver.

Optionally, the mirror head may provide a display and mirror reflective element or EC cell, with the EC cell being flipped via a spring-loaded push-push latch (or powered via a motor).

Optionally, the mirror and display construction may otherwise selectively position the mirror in front of the display and the display in front of the mirror. For example, the mirror display may be assembled directly in front of the reflective mirror, whereby the display could be flipped, slid and/or removed to reveal the reflective mirror, or the reflective mirror could be in front of the display, whereby the reflective mirror could be flipped, slid and/or removed to reveal the display.

The mirror and display may utilize aspects of the mirrors and displays described in PCT Application No. PCT/IB2017/052542, filed May 2, 2017 (Attorney Docket DON01 FP-3034(PCT)), and/or U.S. Publication No. US-2016-0375833 and/or U.S. patent application Ser. No. 15/585,419, filed May 4, 2017 (Attorney Docket DON01 P-3024), and/or U.S. provisional applications, Ser. No. 62/501,263, filed May 4, 2017, Ser. No. 62/476,951, filed Mar. 27, 2017, Ser. No. 62/471,492, filed Mar. 15, 2017, Ser. No. 62/466,089, filed Mar. 2, 2017, and/or Ser. No. 62/355,460, filed Jun. 28, 2016, which are all hereby incorporated herein by reference in their entireties.

Optionally, a camera and/or a non-image sensor may be disposed in the vehicle that views or senses through the windshield of the vehicle or through the rear window of the vehicle. Optionally, the windshield and/or rear window may include a clear portion (non-tinted) to enhance viewing or sensing by the camera/sensor. This allows as much light to get to the camera as possible. Often, for example, rear windows are tinted so as to have a dark tint that is typically impregnated into the glass, which hinders mounting the rearward viewing camera inside the rear window. By having a small portion or window within the window that did not have this tint, this mounting position could be better utilized. Also, by having the camera at that location (behind the window), the camera can be kept free of contamination and water droplets as the window would be cleaned by the rear window wiper/sprayer system.

Optionally, the windshield may have a window or region where there is no IR/UV blocking, such as for use with a LIDAR sensor mounted behind the windshield (such as at the mirror head or bracket or mirror mount or windshield accessory module or the like). Such optical sensors are not typically mounted behind the windshield because of the IR/UV blocking characteristics of the vehicle windshield.

Aspects of the present invention may also be used in video mirrors such as those described in U.S. Pat. No. 9,057,875 and/or in U.S. Publication No. US-2014-0347488, which are hereby incorporated by reference herein in their entireties. In such video mirrors that utilize a full-screen or near full-screen video display, an actuator device is adjustable to tilt a mirrored glass element in one direction, thereby moving the mirrored glass element to an off-axis position which approximately simultaneously changes the on/off state of a video display module. The actuator device is also adjustable to tilt the glass element in another direction, thereby moving the glass element to an on-axis position which approximately simultaneously changes the on/off state of the display module. The mirror assembly and display and adjustment may utilize aspects of the mirror assemblies described in U.S. Pat. No. 9,205,780, which is hereby incorporated herein by reference in its entirety.

The display device may also be controlled or operable in response to an input or signal, such as a signal received from one or more cameras or image sensors of the vehicle, such as a video camera or sensor, such as a CMOS imaging array sensor, a CCD sensor or the like, and image processors or image processing techniques, such as utilizing aspects of the cameras and image processors described U.S. Pat. Nos. 5,550,677; 5,670,935; 5,760,962; 6,498,620; 6,396,397; 6,222,447; 6,201,642; 6,097,023; 5,877,897; 5,796,094; 5,715,093; 6,922,292; 6,757,109; 6,717,610; 6,590,719; 6,320,176; 6,559,435; 6,831,261; 6,806,452; 6,822,563; 6,946,978; 7,038,577; 7,004,606 and/or 7,720,580, and/or U.S. Pat. Pub. Nos. US-2006-0171704; US-2009-0244361 and/or US-2010-0214791, and/or International Publication Nos. WO 2009/046268 and/or WO 2009/036176, which are all hereby incorporated herein by reference in their entireties, or from one or more imaging systems of the vehicle, such as a reverse or backup aid system, such as a rearward directed vehicle vision system utilizing principles disclosed in U.S. Pat. Nos. 5,550,677; 5,760,962; 5,670,935; 6,201,642; 6,396,397; 6,498,620; 6,717,610 and/or 6,757,109, which are hereby incorporated herein by reference in their entireties, a trailer hitching aid or tow check system, such as the type disclosed in U.S. Pat. No. 7,005,974, which is hereby incorporated herein by reference in its entirety, a cabin viewing or monitoring device or system, such as a baby viewing or rear seat viewing camera or device or system or the like, such as disclosed in U.S. Pat. Nos. 5,877,897 and/or 6,690,268, which are hereby incorporated herein by reference in their entireties, a video communication device or system, such as disclosed in U.S. Pat. No. 6,690,268, which is hereby incorporated herein by reference in its entirety, and/or the like. The imaging sensor or camera may be activated and the display screen may be activated (and the mirror head may rotate or pivot to the display mode or position) in response to the vehicle shifting into reverse, such that the display screen is viewable by the driver and is displaying an image of the rearward scene while the driver is reversing the vehicle. It is envisioned that an image processor or controller (such as an EyeQ™ image processing chip available from Mobileye Vision Technologies Ltd. of Jerusalem, Israel, and such as an image processor of the types described in International Pub. No. WO 2010/099416, which is hereby incorporated herein by reference in its entirety) may process image data captured by the rearward facing camera to assess glare lighting conditions (such as to detect headlights of following vehicles that may cause glare at the interior and/or exterior rearview mirror assemblies of the equipped vehicle), and the controller may adjust or control the dimming of the electro-optic mirror assembly or assemblies of the equipped vehicle responsive to such image processing.

Because the display screen may be active for prolonged periods of time, the mirror head and/or display screen or module preferably includes heat dissipating means, such as a heatsink or the like. Optionally, the housing may comprise a heat reducing or heat dissipating material, such as aluminum, plastic and/or magnesium or the like.

The mirror assembly may also include user actuatable inputs operable to control any of the accessories of or associated with the mirror assembly and/or an accessory module or the like. The user input may incorporate one or more touch or proximity sensitive user inputs and associated icons or the like so a user can readily identify the purpose or function of the user inputs and actuate the appropriate or desired or selected user input. For example, the mirror assembly may include touch sensitive elements or touch sensors or proximity sensors (such as at either or both of the mirror reflective element and the display screen), such as the types of touch sensitive elements described in U.S. Pat. Nos. 5,594,222; 6,001,486; 6,310,611; 6,320,282; 6,627,918; 7,224,324 and/or 7,253,723, and/or International Publication Nos. WO 2012/051500 and/or WO 2013/071070, which are hereby incorporated herein by reference in their entireties, or such as proximity sensors of the types described in U.S. Pat. Nos. 7,224,324; 7,249,860 and/or 7,446,924, and/or International Publication No. WO 2004/058540, which are hereby incorporated herein by reference in their entireties, or such as membrane type switches, such as described in U.S. Pat. No. 7,360,932, which is hereby incorporated herein by reference in its entirety, or such as detectors and the like, such as the types disclosed in U.S. Pat. Nos. 7,255,541; 6,504,531; 6,501,465; 6,492,980; 6,452,479; 6,437,258 and/or 6,369,804, which are hereby incorporated herein by reference in their entireties, and/or the like, while remaining within the spirit and scope of the present invention.

Optionally, the user inputs or buttons may comprise user inputs for a garage door opening system, such as a vehicle based garage door opening system of the types described in U.S. Pat. Nos. 6,396,408; 6,362,771; 7,023,322 and/or 5,798,688, which are hereby incorporated herein by reference in their entireties. Optionally, the user inputs may also or otherwise comprise user inputs for a telematics system of the vehicle, such as, for example, an ONSTAR® system as found in General Motors vehicles and/or such as described in U.S. Pat. Nos. 4,862,594; 4,937,945; 5,131,154; 5,255,442; 5,632,092; 5,798,688; 5,971,552; 5,924,212; 6,243,003; 6,278,377; 6,420,975; 6,477,464; 6,946,978; 7,308,341; 7,167,796; 7,004,593; 7,657,052 and/or 6,678,614, and/or U.S. Pat. Pub. No. US-2006-0050018, which are all hereby incorporated herein by reference in their entireties. Optionally, the mirror assembly and/or any associated user inputs may be associated with various accessories or systems, such as, for example, a tire pressure monitoring system or a passenger air bag status or a garage door opening system or a telematics system or any other accessory or system of the mirror assembly or of the vehicle or of an accessory module or console of the vehicle, such as an accessory module or console of the types described in U.S. Pat. Nos. 7,289,037; 6,877,888; 6,824,281; 6,690,268; 6,672,744; 6,386,742 and/or 6,124,886, which are hereby incorporated herein by reference in their entireties.

The mirror assembly may comprise any suitable construction, such as, for example, a mirror assembly with the reflective element being nested in the mirror casing and with a bezel portion that circumscribes a perimeter region of the front surface of the reflective element, or with the mirror casing having a curved or beveled perimeter edge around the reflective element and with no overlap onto the front surface of the reflective element (such as by utilizing aspects of the mirror assemblies described in U.S. Pat. Nos. 7,255,451; 7,289,037; 7,360,932; 8,049,640; 8,277,059 and/or 8,529,108, or such as a mirror assembly having a rear substrate of an electro-optic or electrochromic reflective element nested in the mirror casing, and with the front substrate having curved or beveled perimeter edges, or such as a mirror assembly having a prismatic reflective element that is disposed at an outer perimeter edge of the mirror casing and with the prismatic substrate having curved or beveled perimeter edges, such as described in U.S. Des. Pat. Nos. D633,423; D633,019; D638,761 and/or D647,017, and/or International Publication Nos. WO 2010/124064; WO 2011/044312; WO 2012/051500; WO 2013/071070 and/or WO 2013/126719, which are hereby incorporated herein by reference in their entireties (and with electrochromic and prismatic mirrors of such construction are commercially available from the assignee of this application under the trade name INFINITY™ mirror).

As discussed above, the mirror assembly may comprise an electro-optic or electrochromic mirror assembly that includes an electro-optic or electrochromic reflective element. The perimeter edges of the reflective element may be encased or encompassed by the perimeter element or portion of the bezel portion to conceal and contain and envelop the perimeter edges of the substrates and the perimeter seal disposed therebetween. The electrochromic mirror element of the electrochromic mirror assembly may utilize the principles disclosed in commonly assigned U.S. Pat. Nos. 7,274,501; 7,255,451; 7,195,381; 7,184,190; 6,690,268; 5,140,455; 5,151,816; 6,178,034; 6,154,306; 6,002,544; 5,567,360; 5,525,264; 5,610,756; 5,406,414; 5,253,109; 5,076,673; 5,073,012; 5,117,346; 5,724,187; 5,668,663; 5,910,854; 5,142,407 and/or 4,712,879, which are hereby incorporated herein by reference in their entireties.

Although shown as an electrochromic mirror application, it is envisioned that the mirror assembly may comprise a prismatic reflective element, while remaining within the spirit and scope of the present invention. The prismatic mirror assembly may be mounted or attached at an interior portion of a vehicle (such as at an interior surface of a vehicle windshield) via the mounting means described above, and the reflective element may be toggled or flipped or adjusted between its daytime reflectivity position and its nighttime reflectivity position via any suitable toggle means, such as by utilizing aspects of the mirror assemblies described in U.S. Pat. Nos. 6,318,870 and/or 7,249,860, and/or U.S. Publication No. US-2010-0085653, which are hereby incorporated herein by reference in their entireties. Optionally, for example, the interior rearview mirror assembly may comprise a prismatic mirror assembly, such as the types described in U.S. Pat. Nos. 7,289,037; 7,249,860; 6,318,870; 6,598,980; 5,327,288; 4,948,242; 4,826,289; 4,436,371 and/or 4,435,042, which are hereby incorporated herein by reference in their entireties. Optionally, the prismatic reflective element may comprise a conventional prismatic reflective element or prism or may comprise a prismatic reflective element of the types described in U.S. Pat. Nos. 7,420,756; 7,289,037; 7,274,501; 7,249,860; 7,338,177 and/or 7,255,451, which are all hereby incorporated herein by reference in their entireties, without affecting the scope of the present invention. A variety of mirror accessories and constructions are known in the art, such as those disclosed in U.S. Pat. Nos. 5,555,136; 5,582,383; 5,680,263; 5,984,482; 6,227,675; 6,229,319 and/or 6,315,421 (which are hereby incorporated herein by reference in their entireties), that can benefit from the present invention.

Optionally, the reflective element may include an opaque or substantially opaque or hiding perimeter layer or coating or band disposed around a perimeter edge region of the front substrate (such as at a perimeter region of the rear or second surface of the front substrate) to conceal or hide or the perimeter seal from viewing by the driver of the vehicle when the mirror assembly is normally mounted in the vehicle. Such a hiding layer or perimeter band may be reflective or not reflective and may utilize aspects of the perimeter bands and mirror assemblies described in U.S. Pat. Nos. 5,066,112; 7,626,749; 7,274,501; 7,184,190 and/or 7,255,451, and/or International Publication Nos. WO 2010/124064 and/or WO 2011/044312, which are all hereby incorporated herein by reference in their entireties.

Optionally, the mirror assembly may include one or more other accessories at or within the mirror casing, such as one or more electrical or electronic devices or accessories, such as antennas, including global positioning system (GPS) or cellular phone antennas, such as disclosed in U.S. Pat. No. 5,971,552, a communication module, such as disclosed in U.S. Pat. No. 5,798,688, a blind spot detection system, such as disclosed in U.S. Pat. Nos. 5,929,786 and/or 5,786,772, transmitters and/or receivers, such as a garage door opener or the like, a digital network, such as described in U.S. Pat. No. 5,798,575, a high/low headlamp controller, such as disclosed in U.S. Pat. Nos. 5,796,094 and/or 5,715,093, a memory mirror system, such as disclosed in U.S. Pat. No. 5,796,176, a hands-free phone attachment, a video device for internal cabin surveillance and/or video telephone function, such as disclosed in U.S. Pat. Nos. 5,760,962 and/or 5,877,897, a remote keyless entry receiver, lights, such as map reading lights or one or more other lights or illumination sources, such as disclosed in U.S. Pat. Nos. 6,690,268; 5,938,321; 5,813,745; 5,820,245; 5,673,994; 5,649,756; 5,178,448; 5,671,996; 4,646,210; 4,733,336; 4,807,096; 6,042,253; 5,669,698; 7,195,381; 6,971,775 and/or 7,249,860, microphones, such as disclosed in U.S. Pat. Nos. 7,657,052; 6,243,003; 6,278,377 and/or 6,420,975, speakers, antennas, including global positioning system (GPS) or cellular phone antennas, such as disclosed in U.S. Pat. No. 5,971,552, a communication module, such as disclosed in U.S. Pat. No. 5,798,688, a voice recorder, a blind spot detection system, such as disclosed in U.S. Pat. Nos. 7,720,580; 7,038,577; 6,882,287; 5,929,786 and/or 5,786,772, transmitters and/or receivers, such as for a garage door opener or a vehicle door unlocking system or the like (such as a remote keyless entry system), a digital network, such as described in U.S. Pat. No. 5,798,575, a high/low headlamp controller, such as a camera-based headlamp control, such as disclosed in U.S. Pat. Nos. 5,796,094 and/or 5,715,093, a memory mirror system, such as disclosed in U.S. Pat. No. 5,796,176, a hands-free phone attachment, an imaging system or components or circuitry or display thereof, such as an imaging and/or display system of the types described in U.S. Pat. Nos. 7,400,435; 7,526,103; 6,690,268 and/or 6,847,487, and/or U.S. Pat. Pub. No. US-2006-0125919, a video device for internal cabin surveillance (such as for sleep detection or driver drowsiness detection or the like) and/or video telephone function, such as disclosed in U.S. Pat. Nos. 5,760,962 and/or 5,877,897, a remote keyless entry receiver, a seat occupancy detector, a remote starter control, a yaw sensor, a clock, a carbon monoxide detector, status displays, such as displays that display a status of a door of the vehicle, a transmission selection (4wd/2wd or traction control (TCS) or the like), an antilock braking system, a road condition (that may warn the driver of icy road conditions) and/or the like, a trip computer, a tire pressure monitoring system (TPMS) receiver (such as described in U.S. Pat. Nos. 6,124,647; 6,294,989; 6,445,287; 6,472,979; 6,731,205 and/or 7,423,522, and/or an ONSTAR® system, a compass, such as disclosed in U.S. Pat. Nos. 5,924,212; 4,862,594; 4,937,945; 5,131,154; 5,255,442 and/or 5,632,092, and/or any other accessory or circuitry or the like (with all of the above-referenced patents and publications being commonly assigned and being hereby incorporated herein by reference in their entireties).

Changes and modifications in the specifically described embodiments may be carried out without departing from the principles of the present invention, which is intended to be limited only by the scope of the appended claims as interpreted according to the principles of patent law.

1. An interior rearview mirror assembly for a vehicle, said interior rearview mirror assembly comprising:
a mirror-display assembly adapted to pivotally attach at an interior portion of a vehicle equipped with said interior rearview mirror assembly;
said mirror-display assembly comprising a mirror reflective element;
said mirror-display assembly comprising a display device that has a display screen;
wherein said mirror reflective element is disposed at a mirror side of said mirror-display assembly and wherein said display screen is disposed at a display side of said mirror-display assembly, and wherein said display side is opposite said mirror side;
wherein said mirror-display assembly is pivotable between a mirror position and a display position, and wherein, when said mirror-display assembly is in the mirror position, a driver of the vehicle views said mirror reflective element and does not view said display screen, and wherein, when said mirror-display assembly is in the display position, the driver of the vehicle views said display screen and does not view said mirror reflective element; and
wherein said mirror-display assembly pivots about a pivot axis between the mirror position and the display position.

2. The interior rearview mirror assembly of claim 1, wherein said mirror-display assembly is pivotally mounted to a mounting structure that is configured to attach at the interior portion of the vehicle.

3. The interior rearview mirror assembly of claim 2, wherein said mirror-display assembly is pivotable relative to said mounting structure about a horizontal pivot axis.

4. The interior rearview mirror assembly of claim 3, wherein said mirror-display assembly is pivoted via a motorized actuator disposed in said mirror-display assembly.

5. The interior rearview mirror assembly of claim 3, wherein said mounting structure allows for pivotal adjustment of said mirror-display assembly about at least one other axis relative to the interior portion of the vehicle.

6. The interior rearview mirror assembly of claim 1, wherein said mirror-display assembly is pivotally mounted at a bracket that is pivotally mounted at a mounting structure that is configured to attach at an interior portion of the vehicle.

7. The interior rearview mirror assembly of claim 6, wherein said bracket pivotally attaches at opposite ends of said mirror-display assembly.

8. The interior rearview mirror assembly of claim 6, wherein said bracket pivotally mounts at said mounting structure via a ball and socket pivot joint.

9. The interior rearview mirror assembly of claim 1, wherein said mirror-display assembly is automatically pivoted to said display position in response to a triggering event.

10. The interior rearview mirror assembly of claim 9, wherein said triggering event comprises shifting the vehicle transmission to a reverse gear.

11. The interior rearview mirror assembly of claim 1, wherein said display device is not activated when said mirror-display assembly is in the mirror position.

12. The interior rearview mirror assembly of claim 1, wherein said mirror reflective element comprises an electrically variable reflectance mirror reflective element, and wherein a mirror dimming driver is not activated when said mirror-display assembly is in the display position.

13. The interior rearview mirror assembly of claim 1, wherein a planar surface of said mirror reflective element is at an angle of at least about ten degrees relative to a planar surface of said display device, and wherein, when said mirror-display device is at the display position, said mirror reflective element is angled upward or downward.

14. The interior rearview mirror assembly of claim 1, wherein a planar surface of said mirror reflective element is at a sideward angle of at least ten degrees relative to a planar surface of said display device.

15. An interior rearview mirror assembly for a vehicle, said interior rearview mirror assembly comprising:
a mirror-display assembly pivotally mounted at a bracket, wherein said bracket is pivotally mounted at a mounting structure that is configured to attach at an interior portion of a vehicle equipped with said interior rearview mirror assembly;
said mirror-display assembly comprising a mirror reflective element, wherein said mirror reflective element comprises an electrically variable reflectance mirror reflective element;
said mirror-display assembly comprising a display device that has a display screen;
wherein said mirror reflective element is disposed at a mirror side of said mirror-display assembly and wherein said display screen is disposed at a display side of said mirror-display assembly, and wherein said display side is opposite said mirror side;
wherein said mirror-display assembly is pivotable between a mirror position and a display position, and wherein, when said mirror-display assembly is in the mirror position, a driver of the vehicle views said mirror reflective element and does not view said display screen, and wherein, when said mirror-display assembly is in the display position, the driver of the vehicle views said display screen and does not view said mirror reflective element;
wherein said mirror-display assembly pivots about a pivot axis between the mirror position and the display position;
wherein said mirror-display assembly is pivoted via a motorized actuator disposed at one of said mirror-display assembly and said bracket; and
wherein said mirror-display assembly comprises circuitry, and wherein wiring is routed through said mounting structure and said bracket to electrically connect to said motorized actuator and said circuitry.

16. The interior rearview mirror assembly of claim 15, wherein said bracket pivotally attaches at opposite ends of said mirror-display assembly.

17. The interior rearview mirror assembly of claim 15, wherein said bracket pivotally mounts at said mounting structure via a ball and socket pivot joint.

18. An interior rearview mirror assembly for a vehicle, said interior rearview mirror assembly comprising:
a mirror-display assembly pivotally mounted at a bracket, wherein said bracket is pivotally mounted at a mounting structure that is configured to attach at an interior portion of a vehicle equipped with said interior rearview mirror assembly;
wherein said bracket pivotally mounts at said mounting structure via a ball and socket pivot joint;
said mirror-display assembly comprising a mirror reflective element;
said mirror-display assembly comprising a display device that has a display screen;
wherein said mirror reflective element is disposed at a mirror side of said mirror-display assembly and wherein said display screen is disposed at a display side of said mirror-display assembly, and wherein said display side is opposite said mirror side;
wherein said mirror-display assembly is pivotable between a mirror position and a display position, and wherein, when said mirror-display assembly is in the mirror position, a driver of the vehicle views said mirror reflective element and does not view said display screen, and wherein, when said mirror-display assembly is in the display position, the driver of the vehicle views said display screen and does not view said mirror reflective element;
wherein said mirror-display assembly pivots about a pivot axis between the mirror position and the display position;
wherein said mirror-display assembly is pivoted via a motorized actuator disposed at one of said mirror-display assembly and said bracket;
wherein wiring is routed through said mounting structure and said bracket to electrically connect to said motorized actuator; and
wherein said mirror-display assembly is automatically pivoted to said display position in response to shifting the vehicle transmission to a reverse gear.

19. The interior rearview mirror assembly of claim 18, wherein said display device is not activated when said mirror-display assembly is in the mirror position.

20. The interior rearview mirror assembly of claim 18, wherein said mirror reflective element comprises an electrically variable reflectance mirror reflective element and wherein a mirror dimming driver is not activated when said mirror-display assembly is in the display position.
